(19) United States
(12) Patent Application Publication
(10) Pub. No.: US 2021/0168505 A1
(43) Pub. Date: Jun. 3, 2021

(54) MODULAR SPEAKER SYSTEM

(71) Applicant: Pangissimo LLC, Boston, MA (US)

(72) Inventors: Juncheng Qian, Boston, MA (US); Constantine Hartofilis, Syosset, NY (US); Parsa Shahidi, West Dover, MA (US); Esiri Madagwa, West Hempstead, NY (US)

(21) Appl. No.: 16/922,558

(22) Filed: Jul. 7, 2020

Related U.S. Application Data
(63) Continuation of application No. 16/534,769, filed on Aug. 7, 2019, now Pat. No. 10,869,128.
(60) Provisional application No. 62/715,750, filed on Aug. 7, 2018.

(30) Foreign Application Priority Data
Sep. 20, 2018 (CN) 21821537933.4
Sep. 20, 2018 (CN) 201811098250.8
Sep. 20, 2018 (CN) 201811098350.0
Sep. 20, 2018 (CN) 201821537876.X

(51) Int. Cl. H04R 5/02; H04R 1/02; H04R 3/12; H04R 1/40; H04S 3/00

(52) U.S. Cl. CPC H04R 5/02; H04R 1/025; H04R 3/12; H04S 2400/01; H04R 1/403; H04S 3/008; H04R 2420/07; H04R 1/026

(57) ABSTRACT

Described herein are modular speaker systems including a plurality of wireless speaker modules configured to output sound in a first arrangement and in a second arrangement, in which the first arrangement is different from the second arrangement. In the first arrangement, at least one speaker module can be in physical contact with at least one other speaker module. In the second arrangement, the at least one speaker module can be physically separated from the at least one other speaker module. The plurality of wireless speaker modules may be arranged in any orientation with respect to one another.

### CROSS-REFERENCE TO RELATED APPLICATIONS

This application claims priority and benefit under 35 U.S.C. § 119(e) to U.S. Provisional Patent Application No. 62/715,750 titled “Surroundsound for Personal Electronic Device” and filed on Aug. 7, 2018, and priority to Chinese Utility Model Application No. 201821537933.4 titled “Modular Speaker Wireless Contacts Charging Unit” filed Sep. 20, 2018, Chinese Patent Application No. 201811098350.0 titled “Modular Speaker Wireless Contacts Charging Unit” filed Sep. 20, 2018, Chinese Utility Model Application No. 201821537876.X titled “Modular Stereo Speaker” filed Sep. 20, 2018, and Chinese Patent Application No. 201811098250.8 titled “Modular Stereo Speaker” filed Sep. 20, 2018, the content of each of which is hereby incorporated by reference herein in its entirety.

### TECHNICAL FIELD

The present disclosure relates to speaker systems and more particularly to modular speaker systems configured to output sound in two or more arrangements.

### BACKGROUND

Portable radio sets have been available since the 1920s, and readily carried transistor radios first became publicly available in the 1950s. These early portable entertainment systems typically include a single, i.e., monophonic speaker. In the 1970s, stereophonic “boomboxes” became popular. Some of these portable systems included more than two speakers exhibiting differential frequency response, but generally only two channels of audio information were produced. Additionally, in the 1970s, the first systems for reproducing quadraphonic (i.e., four channel) recordings became available in the consumer market. Generally speaking, these systems were not readily portable.

During the 1980s and 1990s, highly portable recorded music systems became available including Sony Walkman tape player and various compact disc players. These were followed in the late 1990s and early 2000s with various personal electronic devices capable of reproducing recorded music stored in integrated circuit memories.

### SUMMARY

Despite the long-established demand suggested by the history of speaker systems, until the present invention, there was no effective solution providing a highly portable reconfigurable surround sound system adapted for use with personal electronic devices. The present invention provides a highly portable reconfigurable surround sound system adapted for use with portable electronic devices. An exemplary sound system includes two or more modular speakers that a user can orientate as desired. For example, in some embodiments the speaker modules can be physically connected to each other as a single compact item, facilitating easy transportation, storage, and/or display. In other embodiments, a user can physically separate the speakers in distance and arrange them in a room, in different rooms within a house, and/or in an exterior space (e.g., around a campsite, on a beach, in a backyard, etc.). By distributing the speakers around an area, the user can create an immersive surround sound effect. Advantageously, the exemplary modular speakers can be arranged and re-arranged at the user's choosing while continuously outputting sound. In other words, for example, the sound need not be interrupted while a user changes the configuration of the speakers in an area.

In one aspect, the disclosure features a modular speaker system including a plurality of wireless speaker modules configured to output sound in a first arrangement and in a second arrangement, in which the first arrangement is different from the second arrangement. In the first arrangement, at least one speaker module is in physical contact with at least one other speaker module, and in the second arrangement, the at least one speaker module is physically separated from the at least one other speaker module.

Various embodiments of the modular speaker system can include one or more of the following features. In the first arrangement, the at least one speaker module can be in electrical contact with the at least one other speaker module. In the first arrangement, the at least one speaker module can be in magnetic contact with the at least one other speaker module. Each speaker module can include a housing having at least one magnet. The at least one magnet can be configured to induce the magnetic contact between the at least one speaker module and the at least one other speaker module. The wireless speaker modules can include a primary speaker module and at least one secondary speaker module. The primary speaker module can be configured to receive audio data and wirelessly transmit the audio data to the at least one secondary speaker module, and the at least one secondary speaker module can be configured to receive the audio data from the primary speaker module and output sound corresponding to the audio data.

The primary speaker module can be configured to receive the audio data from a user device via a Bluetooth communication channel. The primary speaker module can be configured to wirelessly transmit the audio data to the at least one secondary module via a 2.4 GHz Wi-Fi communication channel or a 5.8 GHz Wi-Fi communication channel. The wireless speaker modules can include at least four wireless speaker modules. A first speaker module can be configured to provide a left-front sound channel; a second speaker module can be configured to provide a right-front sound channel; a third speaker module can be configured to provide a left-back sound channel; and a fourth speaker module is configured to provide a right-back sound channel. The audio data transmitted to the third and fourth speaker modules can have a delay in time relative to the audio data transmitted to the first and second speaker modules. The delay can be approximately 15 milliseconds.

In the first arrangement, the first speaker module, the second speaker module, the third speaker module, and the fourth speaker module can be configured to be arranged in any orientation with respect to each other. The modular speaker system can include a housing adapted to hold the plurality of wireless speaker modules in the first arrangement. The housing can encompass only a portion of each of the plurality of wireless speakers and leaves exposed a sound emitting portion of each of the plurality of wireless speakers. The housing can include a strap to facilitate carrying by a user.

In another aspect, the disclosure features a method of using a modular speaker system. The method can include the steps of providing a plurality of wireless speaker modules configured to output sound in a first arrangement and in a second arrangement, the first arrangement different from the second arrangement. The method can include arranging the wireless speaker modules in the first arrangement or in the second arrangement. In the first arrangement, at least one speaker module is in physical contact with at least one other speaker module, and in the second arrangement, the at least one speaker module is physically separated from the at least one other speaker module.

Various embodiments of the modular speaker system can include one or more of the following features. In the first arrangement, the at least one speaker module can be in electrical contact with the at least one other speaker module. In the first arrangement, the electrical contact can be accomplished by a magnetic contact between the at least one speaker module and the at least one other speaker module. Each speaker module can include a housing having at least one magnet. The at least one magnet can be configured to induce contact between the at least one speaker module and the at least one other speaker module. The wireless speaker modules can include a primary speaker module and at least one secondary speaker module. The method can further include receiving, by the primary speaker module, audio data; wirelessly transmitting, by the primary speaker module, the audio data to the at least one secondary speaker module; and receiving, by the at least one secondary speaker module, the audio data from the primary speaker module for outputting the sound in the first and second arrangements.

The receiving, by the primary speaker module, the audio data can include receiving, by the primary speaker module, the audio data from a user device via a Bluetooth communication channel. The wirelessly transmitting, by the primary speaker module, the audio data to the at least one secondary speaker module can include wirelessly transmitting, by the primary speaker module, the audio data to the at least one secondary speaker module via a 2.4 GHz Wi-Fi communication channel or a 5.8 GHz Wi-Fi communication channel. The wireless speaker modules can include at least four wireless speaker modules. A first speaker module can be configured to provide a left-front sound channel; a second speaker module is configured to provide a right-front sound channel; a third speaker module is configured to provide a left-back sound channel, and a fourth speaker module is configured to provide a right-back sound channel. The method can include transmitting to the third and fourth speaker modules the audio data with a delay in time relative to transmitting the audio data to the first and second speaker modules. The delay can be approximately 15 milliseconds.

These and other objects, along with advantages and features of the embodiments of the present disclosure, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a schematic view of an overview of a surround sound system configured to communicate with a personal electronic device;

FIG. 1B is a diagram of a modular speaker system in which a primary module is configured to communicate with a user device (and a plurality of secondary units;

FIG. 2 is a perspective view of four speaker housings, of which one speaker housing houses a primary module components while the other speaker housings house secondary module components;

FIG. 3A is an enlarged view of an interior portion of an exemplary housing of a speaker module; FIG. 3B is an enlarged view of another interior portion of an exemplary housing of a speaker module; FIG. 3C is a perspective view of the exemplary housings of FIG. 2 in an exemplary arrangement; FIG. 3D is a side view of the exemplary arrangement of FIG. 3C;

FIG. 4A is a schematic view of components of an exemplary primary speaker module; FIG. 4B is a schematic view of components of another exemplary primary speaker module; FIG. 4C is a schematic view of components of an exemplary secondary speaker module;

FIG. 5A is a perspective view of the exterior of exemplary speaker modules in “separate” mode; FIG. 5B is a perspective view of the exterior of speaker modules in “combination” mode;

FIG. 6 is a perspective view of an exemplary housing for speaker modules; and

FIGS. 7A-7B are perspective views of an exemplary modular speaker system, including a subwoofer type of speaker module, in separate mode and combination mode, respectively.

### DETAILED DESCRIPTION

Disclosed herein are various embodiments of highly portable reconfigurable modular speaker systems adapted for use with portable electronic devices (also referred to as user devices). In various exemplary embodiments, the system can be adapted and configured for operative communication with a personal electronic device (e.g., a smart phone, a smart watch, a tablet computer, a laptop computer, a notebook computer, etc.). In various embodiments, the one or more modules of the modular speaker system can be in communication with the personal electronic device via a communication channel (e.g., Bluetooth communication protocol). As referred to herein, a “primary” element (e.g., a module, component, controller, etc.) may be also known as a “master” element, and a “secondary” element (e.g., a module, component, controller, etc.) may be also known as a “slave” element.

### Modular Speaker Systems

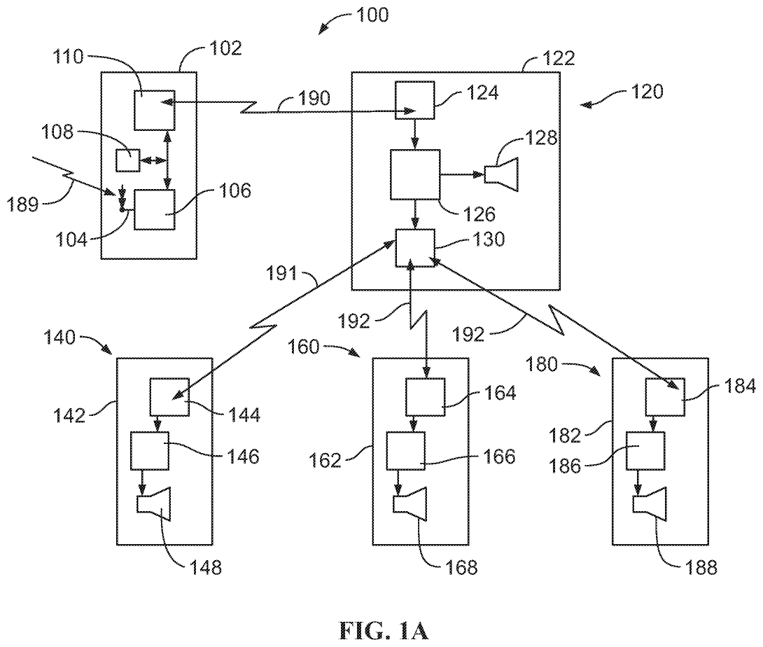

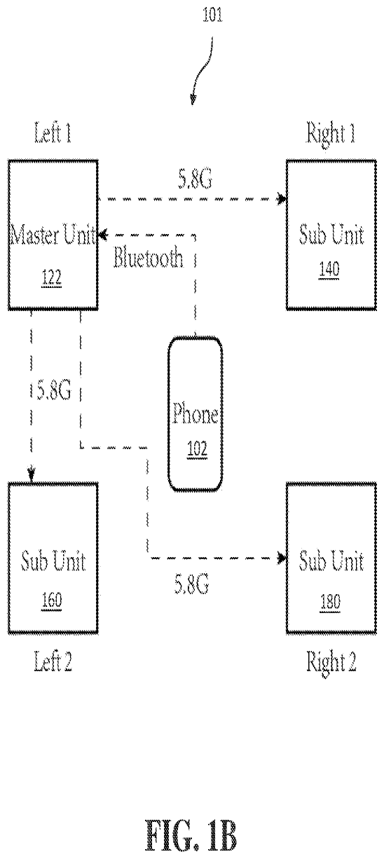

FIG. 1A shows, in schematic block diagram view, an overview of a surround sound system 100 configured to communicate with a personal electronic device 102, e.g., a smart phone. As is typical of a modern smart phone, the illustrated smart phone 102 includes a cell phone signal antenna 104.

The cell phone signal antenna 104 is signalingly coupled to a processing subsystem 106. The processing subsystem 106 typically provides digital codec and signal processing functions, user interface control, software processing and amplification, among other features, as would be known by one of skill in the art. The processing subsystem 106 is signalingly coupled within the personal electronic device 102 to an internal memory device 108, and to a communications subsystem 110 (e.g., a Bluetooth communication subsystem 110, although other communication protocols are possible and contemplated).

The Bluetooth communication subsystem 110 can provide functionality including signal processing, amplification, and telecommunications and typically would include an antenna configured as an antenna adapted to communicate Bluetooth communication signals.

The exemplary surround sound system 100 includes a primary module 120 having a housing 122. Within the housing, is disposed a Bluetooth communication subsystem 124 coupled to a processing and amplification subsystem 126. The processing and amplification subsystem 126 is operatively coupled to an audio speaker device 128 and to a communication subsystem 130.

In one exemplary embodiment, the communication subsystem 130 is arranged to provide a 2.4 GHz radio communication signal and can generate and modulate the carrier signal. The subsystem 130 can include an appropriate antenna device for transmitting and/or receiving communication signals.

The exemplary surround sound system 100 can include a plurality of secondary speaker modules, (e.g., modules 140, 160, and 180). The speaker modules 140, 160, and 180 can be disposed within respective housings 142, 162, and 182. Each secondary module includes a respective communication subsystem, e.g., 144, 164, and 184. The modules' communication subsystems 144, 164, and 184 are operatively coupled to respective amplifier devices, e.g., 146, 166, 186. These amplifier devices are in turn coupled to respective audio speakers, e.g., 148, 168, 188.

In certain exemplary modes of operation, a personal electronic device 102 can receive electromagnetic signal 189 at antenna 104. The electromagnetic signal will encode data representing, for example, an audio entertainment program. Processing subsystem 106 receives further data corresponding to the audio entertainment program and encode the information of that data signal in memory device 108.

In other embodiments of the invention, data is encoded in memory device 108 after having been received directly by, for example, a hardwired connection, or by other programming needs during, for example, manufacturing or preprocessing of the personal electronic device 102, or of the memory device 108.

Data from the memory 108 is received at the Bluetooth communication subsystem 110 and broadcast as an electromagnetic signal 190 according to, for example, a Bluetooth protocol.

This broadcast signal is received by Bluetooth communication subsystem 124 which decodes the signal and provides corresponding data to the processing and amplification subsystem 126. The processing and amplification subsystem 126 provides a digital to analog conversion based on the received data, and produces an analog electrical audio signal which drives the primary module audio speaker device 128.

In addition, the processing and amplification subsystem forwards an analog electrical audio signal to the further communication subsystem 130 which produces a local analog radio signal that is received by respective communications systems, e.g., 144, 164, and 184.

In other embodiments, the processing and amplification subsystem 126 forwards the digital data to the communication subsystem 130 which executes a digital radio communication protocol with communication systems, e.g., 144, 164, 184, configured as digital communication devices.

The signals received at communication systems 144, 164, and 184 are amplified by respective amplifier devices, e.g., 146, 166, and 186 and transduced by audio speaker devices, e.g., 148, 168, and 188, to provide an audible entertainment program within an environment of the system 100.

It will be appreciated by one of skill in the art that the data underlying this audio program can be configured at the personal electronic device 102, the primary module 120, or at the secondary modules 140, 160, 182 produce a surround sound or quadraphonic effect. Accordingly, for example, processing and amplification system 126 can, in certain embodiments, be arranged and configured to provide individualized signals, e.g., 191, 192, and 193, to the individual secondary modules 140, 160, and/or 180. These individualized signals may be transmitted based on a frequency division multiplexing protocol, a time division multiplexing protocol, or any other technical arrangement appropriate to achieve the surround sound effect.

It will be appreciated by one of skill in the art that the foregoing description is schematic and omits certain features including, for example, battery or other energy storage subsystems which are described, for example, below.

### Communication Systems

In various embodiments, the modular speaker system can be configured with communication capability over radio, Wi-Fi, Bluetooth connection, etc. For example, the primary module of the speaker system may communicate with one or more secondary module over 2.4 GHz Wi-Fi communication channel or a 5.8 GHz Wi-Fi communication channel. For example, each module speaker of the system 100 can include a 5.8 GHz Wi-Fi chip configured to pair one module of the system to another module of the system. In a particular embodiment, the primary module is configured to communicate with each secondary module over the 5.8 GHz frequency band. In some cases, Wi-Fi communication may provide for a greater range as compared to Bluetooth communication thereby enabling greater distance between the primary module and the secondary module(s). FIG. 1B is a diagram illustrating a modular speaker system 101 in which a primary module 122 is configured to communicate with a user device 102 (e.g., smart phone) and a plurality of secondary units 140, 160, and 180.

In the exemplary configuration of FIG. 1B, there are four (4) speaker modules (one primary and 3 secondary modules) corresponding to sound channels emulating a first left side (labeled “Left 1”), a second left side (labeled “Left 2), a first right side (labeled “Right 1”), and a second right side (labeled “Right 2”). In this example, the primary module 122 corresponds to the Left 1 sound channel; however, the primary module 122 may correspond to any of the sound channels described herein. In some embodiments, the primary module 122 transmits the audio data to the secondary modules 140, 160, and 180 such that there is a fixed delay in outputting the sound. Specifically, the sound from module 160 (Left 2) and module 180 (Right 2) has a delay in time with sound from module 122 (Left 1) and module 140 (Right 1). In general, any advantageous time delay is possible, e.g., in a range from 1-100 milliseconds, in a range from 5-75 milliseconds, in a range from 7-50 milliseconds, in a range from 9-25 milliseconds, and in a range from 11-20 milliseconds). In some embodiments, the delay is approximately 15 milliseconds.

In some embodiments, by arranging the speaker modules around the user, the four speaker modules can create a surround sound experience for the user positioned approximately in between the four modules 122, 140, 260, and 180 (e.g., at the relative position of the user device 102).

In various embodiments, the primary module 122 receives audio data from a user device 102 via a Bluetooth communication channel. The primary module 122 then transmits the data to each of the secondary modules 140, 160, and 180 via a 5.8 GHz Wi-Fi communication channel. Advantageously, the secondary modules 140, 160, and 180 can be “pre-paired” to the primary module 122 such that individual communication channels do not need to be manually established by the user to start using the speaker system. Conventionally, to set up an “ad hoc” surround sound system using individual unpaired wireless speakers, a user would manually need to establish a communication channel from (or “pair”) one speaker to another speaker. This can be a cumbersome experience because the speakers are not configured to interoperate with other speakers and because pairing between greater numbers of speakers take significant time at the beginning. Therefore, the exemplary systems and methods described herein have the benefit of saving time and effort for the user, thereby generally creating a better user experience. In some embodiments, the user can selectively turn on or off any one or more secondary modules in the modular speaker system without interrupting the sound experience from the remaining module(s) or having to manually pair the secondary module back to the remaining module(s). In other words, a secondary module can automatically connect to the one or more modules of the modular speaker system. This can further creates a more versatile and customizable experience for the user.

### Module Housings

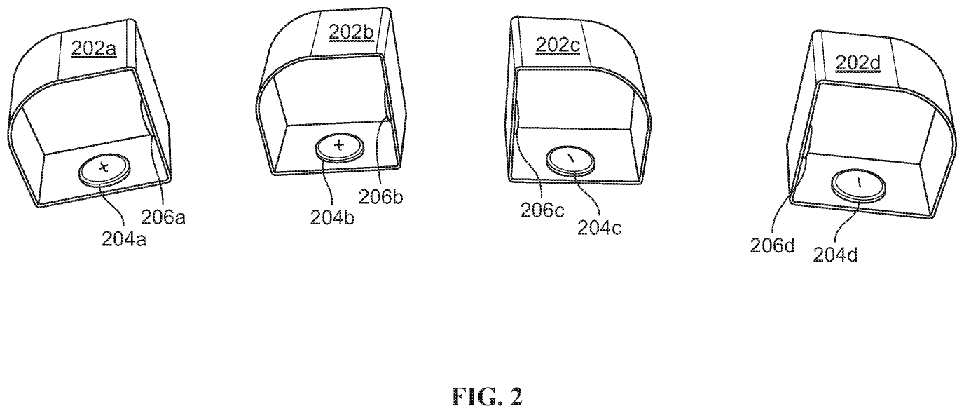

In certain embodiments, the system 100 includes a plurality of speaker modules, each having a respective housing. FIG. 2 illustrates four speaker housings 202a, 202b, 202c, and 202d (collectively referred to as housing(s) 202), of which one speaker housing houses a primary module components while the other speaker housings house secondary module components. In some embodiments, each housing 202 can include one or more coupling devices. Examples of coupling devices can include magnets (e.g., rare earth magnets), latches, or other mechanical means of removably coupling one housing to at least one other housing. For example, housing 202a includes magnets 204a and 206a; housing 202b includes magnets 204b and 206b; housing 202c includes magnets 204c and 206c; and housing 202d includes 204d and 206d. Magnets 204a, 204b, 204c, and 204d are collectively referred to as magnet(s) 204; magnets 206a, 206b, 206c, and 206d are collectively referred to as magnet(s) 206.

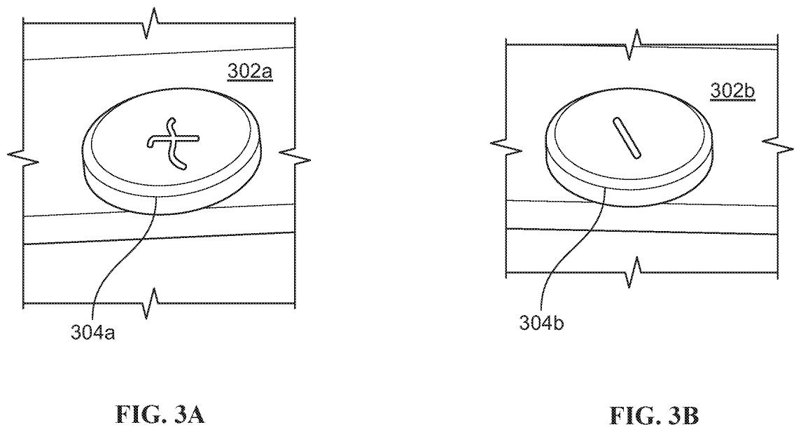

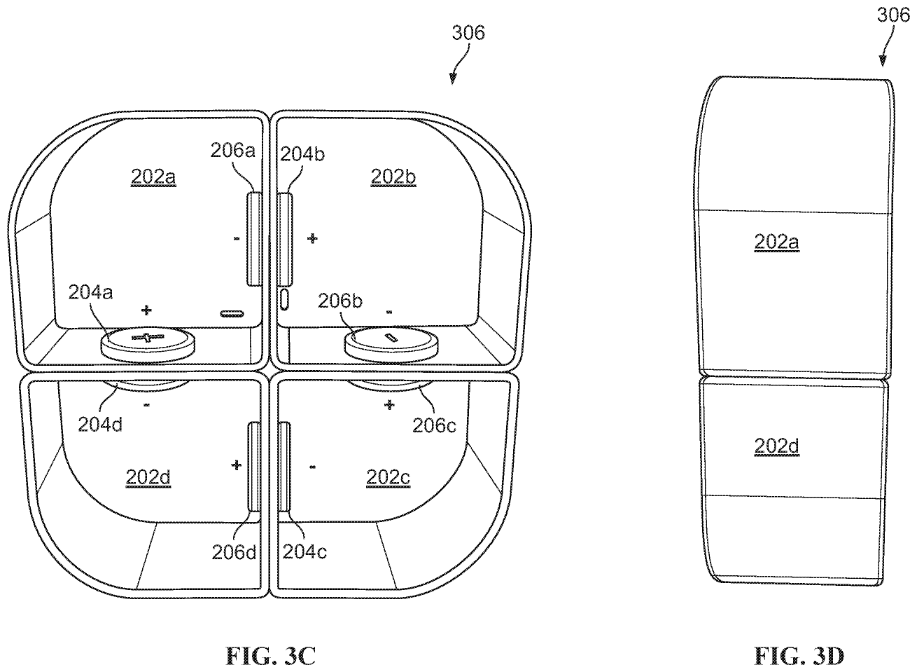

FIG. 3A is an enlarged view of an interior portion 302a of an exemplary housing 202 including two coupling devices 204. FIG. 3B is an enlarged view of another interior portion 302b of an exemplary housing 202. The exemplary housing interior portion 302a includes a first magnet 304a configured such that its North Pole is oriented inward to the interior 302a of the housing 202 and a second magnet configured such that its North Pole is oriented outward from of the housing. The coupling devices (e.g., magnets 204 and 206) are arranged and configured to enable the housings 202 to be coupled to one another. FIG. 3C illustrates an exemplary arrangement 306 of the housings 202, in which two housings 202a, 202b are combined with housings 202c, 202d to form a rectangular shape. In some embodiments, the housings 202 are combined together via the magnets 204, 206, as described herein. FIG. 3D is a side view of the arrangement 306.

In various embodiments, the exemplary housings are arranged and configured to support respective transducers (e.g., audio speakers). In certain embodiments, the respective housings are arranged such that the sound signals can share a common phase when the housing modules are coupled to one another. In certain embodiments, speaker phase may be adjusted to different phase relationships when the housing modules are separated from one another.

### Module Components

In certain embodiments, each of the four modules are identical, both in external form and in contents, to the other three modules. In other embodiments of the invention, one module is a primary module and the other modules will be secondary modules. The primary housing of the primary module may include Bluetooth circuitry arranged and configured for communication with a personal electronic device, or other audio signal source, and additional communication circuitry for wireless communication with the three secondary modules. In some embodiments, the primary module differs from the secondary modules in that it includes components for receiving a charge from an external source (e.g., a battery pack, wall outlet, etc.).

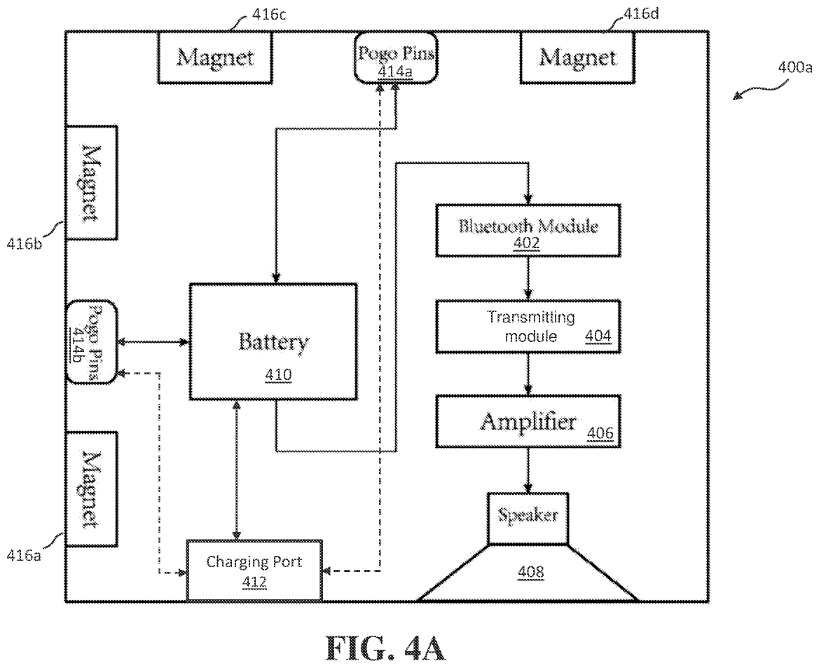

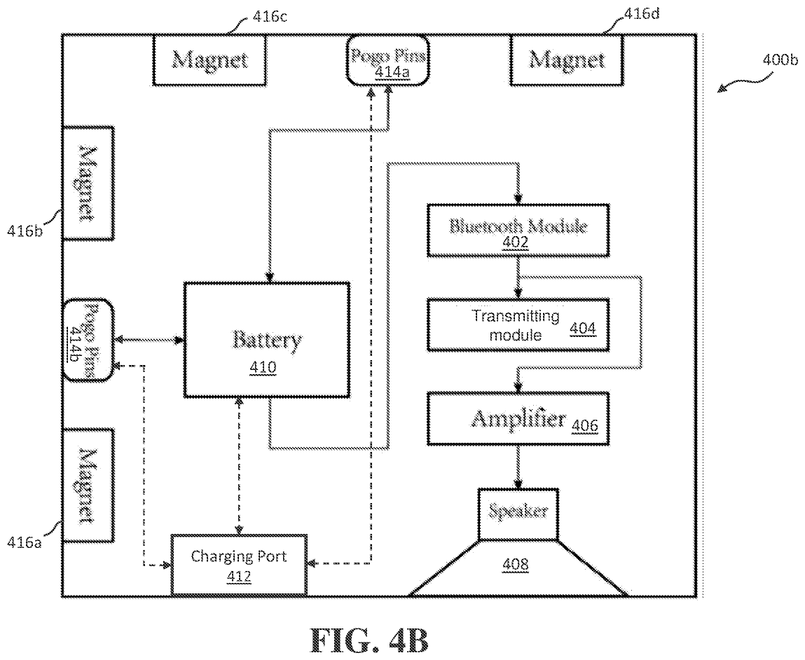

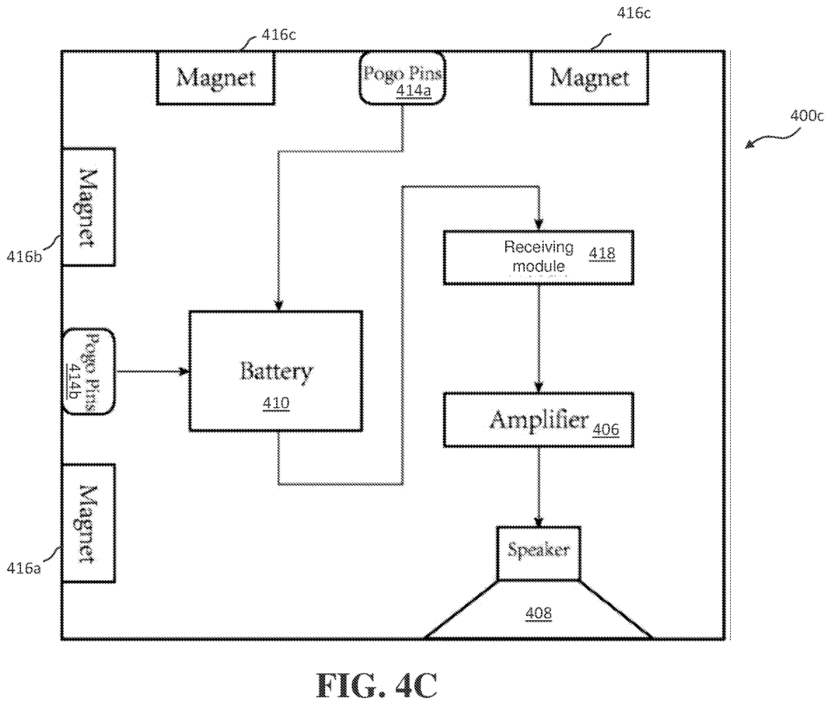

FIG. 4A is a schematic view of components of an exemplary primary speaker module 400a. As described above, the primary module 400a (e.g., primary module 122) can include a Bluetooth module 402 for communicating with a user device 102, a transmitting module 404 for communicating with secondary modules (e.g., module 140, 160, and 180), and an amplifier 406 coupled to a speaker 408 for outputting sound according to the audio data. The primary module 400 can also include energy storage 410 (e.g., a battery, supercapacitor, etc.) configured to provide electrical power to components 402, 404, 406, and/or 408. For example, the battery 410 may be a built-in 2000 mAh Lithium ion battery having an 8-hour capacity and configured to fully charge within 2 hours. In some embodiments, the primary module 400a includes a charging port 412 for receiving power via an electrical outlet. The port 412 may be a USB connection (e.g., via a USB-C power cable), a customized port, etc. In the exemplary embodiment, the battery 410 is electrically coupled to connection ports 414a and 414b for electrically connecting to adjacent speaker modules (e.g., secondary modules 140, 160, or 180) (see also discussion above under heading “Module Housings”). In some embodiments, the connection ports 414a, 414b can be a conductive connection (e.g., via Pogo pins). In some embodiments, the magnet(s) 416a, 416b, 416c, and/or 416d (collectively referred to as 416) can enable adjacent modules to be combined. In this “combination” mode, the primary module 400a can provide an electrical pathway for the secondary modules to be charged. In some embodiments, the charging port 412 may be directly coupled (bypassing battery 410) to the connection ports 414a, 414b for charging adjacent modules.

FIG. 4B is a schematic view of components of another exemplary primary speaker module 400b. In this alternative configuration, the primary module 400b (e.g., primary module 122) includes communication paths from the Bluetooth module 402 separately to the transmitting module 404 and to the amplifier 406.

FIG. 4C is a schematic view of components of an exemplary secondary speaker module 400c. The exemplary secondary module 400c includes a receiving module 418 for receiving audio data from the primary module (e.g., 400a or 400b) coupled to an amplifier 406 and speaker 408 for outputting sound according to the audio data. The receiving module 418 is coupled to a battery 410 for its power needs. The battery 410 can be coupled to each of the connection ports 414a and 414b for charging purposes. As described above, the primary module 400a, 400b can be connected to an external power source via the charging port 412. This power can be ultimately delivered to each of the secondary module(a) 400a via the connection ports 414a, 414b. The secondary module 400c can include magnets 416 to enable combining with adjacent modules.

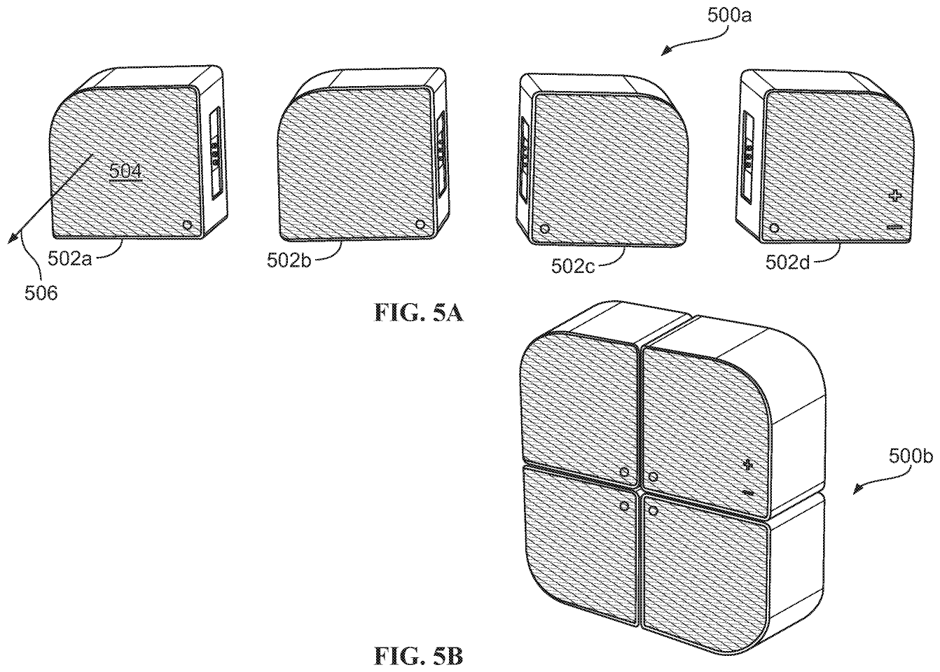

FIG. 5A is a perspective view of the exterior of exemplary speaker modules in “separate” mode 500a. The exemplary modules 502a, 502b, 502c, and 502d (collectively referred to as 502) are distributed in space such that the speaker (not shown) under surface 504 can project sound outward 506. However, modules 502 can be distributed in any arrangement in space. For example, the secondary modules 502b, 502c, 502d can be arranged in nearly endless configurations in space as long as they are within communication range of the primary module 502a (so as to continue projecting sound based on the audio data provided by the primary module). For example, each module 502 has dimensions of approximately 80 mm by approximately 80 mm by approximately 48 mm.

FIG. 5B is a perspective view of the exterior of modules 502 in “combination” mode 500b. In this mode, the modules 502 are arranged so as to contact one another. Such an arrangement can enable to modules 502 to physically operate as a single unit, which can be advantageous for transportation, storage, and/or display purposes. In some embodiments, the arrangement of the modules in combination mode 502 can be orientation agnostic; meaning that any module 502 can occupy any quadrant of the combined speaker. In various embodiments, module 502a can be located in the top left, bottom left, top right, or bottom right quadrant; module 502b can be located in the top left, bottom left, top right, or bottom right quadrant; module 502c can be located in the top left, bottom left, top right, or bottom right quadrant; and/or quadrant 502d can be located in the top left, bottom left, top right, or bottom right quadrant. In other embodiments, one or more of the modules have a predetermined orientation. As discussed above, magnets within the housings of the modules 502 can enable the physical connection between the modules 502 in combination mode 500b. In some instances, the magnetic coupling also enables charging; either because the magnetic connections themselves also perform a charging function or because the magnetic connections facilitate connection of a separate electrical connection. Referring to the above example, the combination of the modules 502 yields dimensions of approximately 160 mm by approximately 160 mm by approximately 48 mm.

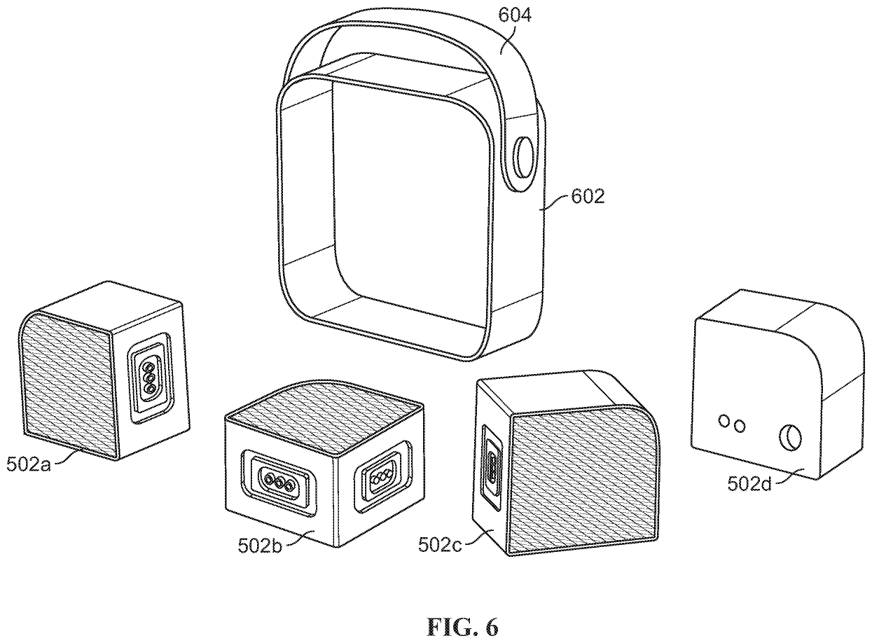

FIG. 6 illustrates an exemplary housing 602 for the modules 502. The housing 602 can be used to mount and/or transport the individual modules. In certain embodiments, the housing 602 can facilitate charging of the modules by holding the modules together in combination mode 500b. The housing 602 can include a handle or strap 604 to facilitate carrying by a user. In some embodiments, the housing 602 has openings such that the sound emitting portions within the modules 502 can be exposed (and therefore enable sound to be better projected in the area surrounding the speaker system).

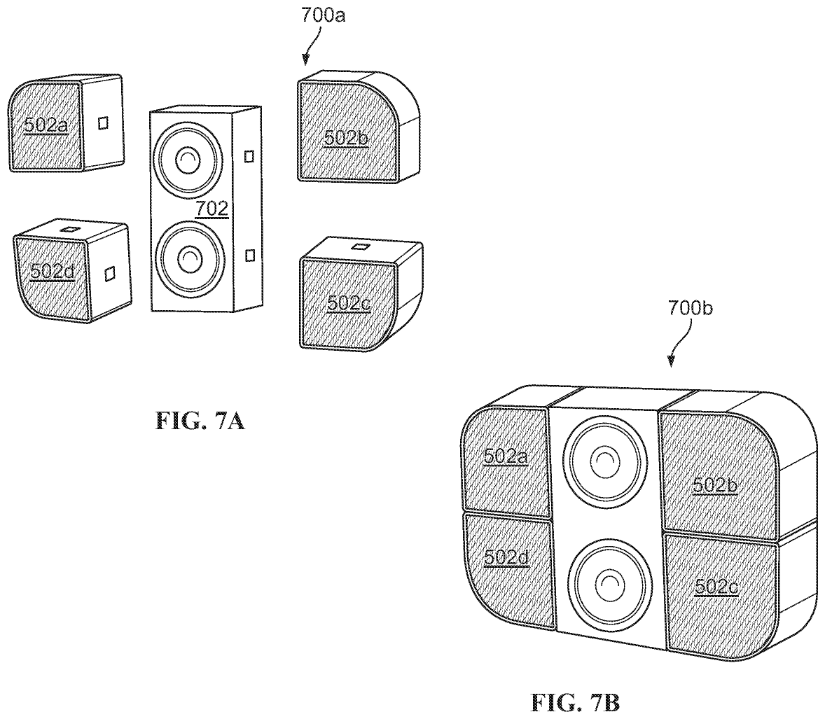

FIGS. 7A-7B illustrate an alternative embodiment of the modular speaker system, including an additional type of speaker module 702, in separate mode 700a and combination mode 700b, respectively. The system includes modules 502 (as described above) configured to couple to a subwoofer-type module 702. The module 702 can include components similar to those described for each of the speaker modules, including a battery, connection pins, magnets, speaker, amplifier, etc. The connection pins of the subwoofer module 702 enable electrical connection to the modules 502.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A modular speaker system comprising:
a plurality of wireless speaker modules configured to output sound in a first arrangement and in a second arrangement, the first arrangement different from the second arrangement, wherein:
in the first arrangement, at least one speaker module is in physical contact with at least one other speaker module, and
in the second arrangement, the at least one speaker module is physically separated from the at least one other speaker module.

2. The speaker system of claim 1, wherein, in the first arrangement, the at least one speaker module is in electrical contact with the at least one other speaker module.

3. The speaker system of claim 1, wherein, in the first arrangement, the at least one speaker module is in magnetic contact with the at least one other speaker module.

4. The speaker system of claim 3, wherein each speaker module comprises a housing having at least one magnet, the at least one magnet configured to induce the magnetic contact between the at least one speaker module and the at least one other speaker module.

5. The speaker system of claim 1, wherein the wireless speaker modules comprise a primary speaker module and at least one secondary speaker module, wherein:
the primary speaker module is configured to receive audio data and wirelessly transmit the audio data to the at least one secondary speaker module, and
the at least one secondary speaker module is configured to receive the audio data from the primary speaker module and output sound corresponding to the audio data.

6. The speaker system of claim 5, wherein the primary speaker module is configured to receive the audio data from a user device via a Bluetooth communication channel.

7. The speaker system of claim 5, wherein the primary speaker module is configured to wirelessly transmit the audio data to the at least one secondary module via a 2.4 GHz Wi-Fi communication channel or a 5.8 GHz Wi-Fi communication channel.

8. The speaker system of claim 1, wherein the wireless speaker modules comprise at least four wireless speaker modules.

9. The speaker system of claim 8, wherein:
a first speaker module is configured to provide a left-front sound channel,
a second speaker module is configured to provide a right-front sound channel,
a third speaker module is configured to provide a left-back sound channel, and
a fourth speaker module is configured to provide a right-back sound channel; and wherein audio data transmitted to the third and fourth speaker modules has a delay in time relative to the audio data transmitted to the first and second speaker modules.

10. The speaker system of claim 9, wherein the delay is approximately 15 milliseconds.

11. The speaker system of claim 9, wherein in the first arrangement the first speaker module, the second speaker module, the third speaker module, and the fourth speaker module are configured to be arranged in any orientation with respect to each other.

12. The speaker system of claim 1, further comprising a housing adapted to hold the plurality of wireless speaker modules in the first arrangement.

13. The speaker system of claim 12, wherein the housing encompasses only a portion of each of the plurality of wireless speakers and leaves exposed a sound emitting portion of each of the plurality of wireless speakers.

14. The speaker system of claim 12, wherein the housing comprises a strap to facilitate carrying by a user.

15. A method of using a modular speaker system, the method comprising the steps of:
providing a plurality of wireless speaker modules configured to output sound in a first arrangement and in a second arrangement, the first arrangement different from the second arrangement; and
arranging the wireless speaker modules in the first arrangement or in the second arrangement, wherein:
in the first arrangement, at least one speaker module is in physical contact with at least one other speaker module, and
in the second arrangement, the at least one speaker module is physically separated from the at least one other speaker module.

16. The method of claim 15, wherein, in the first arrangement, the at least one speaker module is in electrical contact with the at least one other speaker module.

17. The method of claim 16, wherein, in the first arrangement, the electrical contact is accomplished by a magnetic contact between the at least one speaker module and the at least one other speaker module.

18. The method of claim 17, wherein each speaker module comprises a housing having at least one magnet, the at least one magnet configured to induce contact between the at least one speaker module and the at least one other speaker module.

19. The method of claim 15, wherein the wireless speaker modules comprise a primary speaker module and at least one secondary speaker module, the method further comprising:
receiving, by the primary speaker module, audio data;
wirelessly transmitting, by the primary speaker module, the audio data to the at least one secondary speaker module; and
receiving, by the at least one secondary speaker module, the audio data from the primary speaker module for outputting the sound in the first and second arrangements.

20. The method of claim 19, wherein receiving, by the primary speaker module, the audio data comprises:
receiving, by the primary speaker module, the audio data from a user device via a Bluetooth communication channel.

21. The method of claim 19, wherein wirelessly transmitting, by the primary speaker module, the audio data to the at least one secondary speaker module comprises:
wirelessly transmitting, by the primary speaker module, the audio data to the at least one secondary speaker module via a 2.4 GHz Wi-Fi communication channel or a 5.8 GHz Wi-Fi communication channel.

22. The method of claim 15, wherein the wireless speaker modules comprise at least four wireless speaker modules.

23. The method of claim 22, wherein:
a first speaker module is configured to provide a left-front sound channel,
a second speaker module is configured to provide a right-front sound channel,
a third speaker module is configured to provide a left-back sound channel, and
a fourth speaker module is configured to provide a right-back sound channel; the method comprising:
transmitting to the third and fourth speaker modules the audio data with a delay in time relative to transmitting the audio data to the first and second speaker modules.

24. The method of claim 22, wherein the delay is approximately 15 milliseconds.
